(19) United States
(12) Patent Application Publication
(10) Pub. No.: US 2005/0143031 A1
(43) Pub. Date: Jun. 30, 2005

(54) Multi-band receiver

(76) Inventors: Oswald Moonen, Eindhoven (NL); Peter Johannus Henricus Rutten, Eindhoven (NL); Stephanus Josephus Maria Crijns, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/503,789

(22) PCT Filed: Jan. 21, 2002
(86) PCT No.: PCT/IB03/00190

(30) Foreign Application Priority Data
Feb. 6, 2002 (EP) 02075494.1

(51) Int. Cl. H04B 1/18

(52) U.S. Cl. 455/168.1; 455/161.1

(57) ABSTRACT

A multi-band receiver for receiving an input signal having a frequency situated either in a first band or in a second band. The receiver comprising a mixer for combining an amplified signal having substantially the same frequency as the input signal with a periodical signal generated by a local oscillator. The mixer generates an intermediate frequency signal, the intermediate frequency signal (IF) being inputted to an IF band-pass filter. A central frequency of the band-pass filter is substantially equal to a frequency of the intermediate frequency signal. The receiver is characterized in that the central frequency of the IF band-pass filter is substantially independent of a combining mode of the amplified signal and the periodical signal, the combining mode being selected from an upper heterodyning mode and a lower heterodyning mode.

The invention relates to a multiple band receiver as described in the preamble of claim 1.

Frequency bands for communication networks are defined in international and national standards such as IEEE 802.11a and HIPERLAN. Their frequency bands are [2.4-2.5] GHz according to HIPERLAN and [5.2-5.8] GHz according to IEEE 802.11a. A heterodyne receiver transforms a frequency of an input signal into an intermediate frequency (IF) signal. This transformation is realized in a mixer that combines the input signal with a signal generated by a local oscillator. The result of this combination is an IF signal. The IF signal has a frequency representing either the difference between the oscillator frequency and the frequency of the input signal in so called upper heterodyning mode or the difference between the frequency of the input signal and the oscillator frequency in so called lower heterodyning mode. Normally, a receiver for receiving signals situated in different frequency bands has different oscillators, one for each band or group of bands, if possible. Reducing the number of oscillators has multiple benefits as reducing costs, reducing the size of the receiver, reducing the complexity of the circuits that are used for building the oscillator and the input circuits.

Such a solution is known from U.S. Pat. No. 4,132,952. In this patent application a multi-band tuner with fixed broadband input filters is presented. The receiver described in this document is used for receiving broadcasting video frequency signals that are situated in two frequency bands spaced from each other. The IF band is selected such that the image frequency rejection is improved. Furthermore a mixer used in this invention could be either in upper heterodyning mode or in lower heterodyning mode. In this case two selectable band-pass filters are used. A first band-pass filter is used for selecting the frequency resulting when upper heterodyning mode is used. A second band-pass filter for selecting the frequency resulted when lower heterodyning is used. It should be mentioned here that the oscillator must be a variable frequency oscillator having a minimum frequency (fₘᵢₙ) and a maximum frequency (fₘₐₓ). In the presented embodiments the ratio fₘₐₓ/fₘᵢₙ is greater that 2. It must be observed that the above ratio is hard to be realized for oscillators operating in relatively high frequency ranges e.g. Ghz. The local oscillators are normally voltage controlled and when low voltage operation is necessary, as in relatively high frequency systems, the voltage range is not sufficient for controlling the oscillation frequency. Furthermore, in order to reduce costs it is desirable to use as few as possible components.

It is therefore an object of present invention to provide a multiple band receiver having a relatively low cost.

In accordance with the invention this is achieved in a device as described in the preamble of claim 1 being characterized in that the central frequency of the IF band-pass filter is substantially independent of a combining mode of the amplified signal and the periodical signal, the combining mode being selected from an upper heterodyning mode and a lower heterodyning mode.

In the upper heterodyning mode, the intermediate frequency (IF) signal has a frequency representing the difference between the frequency of the amplified signal and the frequency of the periodical signal. If the amplified signal is included in different bands a carefully chosen IF signal is such that f_{IF}=f_{RF}−f_{OSC} in upper heterodyning mode and f_{IF}=f_{OSC}−f_{RF} in lower heterodyning mode. In previous relations fIF is the frequency of the IF signal, f_{OSC} is the frequency of the periodical signal generated by the oscillator and f_{RF} is the frequency of the input signal. In this way, a receiver for receiving signals situated in different bands uses only one oscillator. Furthermore, because the frequency of the IF signal does not depend on how the signals are combined in the mixer, only one band-pass filter having a central frequency substantially equal to the frequency of the IF signal is necessary. The band-pass filter could comprise a plurality of image rejection filters for rejecting image frequencies that appear either in upper heterodyning mode or in lower heterodyning mode. It is observed that the tuned frequencies of image rejection filters are controllable using an external signal for indicating whether upper heterodyning mode or lower heterodyning mode is performed. Using only one band-pass filter for the IF signal and only one local oscillator, the multiple band receiver is relatively cheap and easy to be built.

The above and other features and advantages of the invention will be apparent from the following description of the exemplary embodiments of the invention with reference to the accompanying drawings, in which:

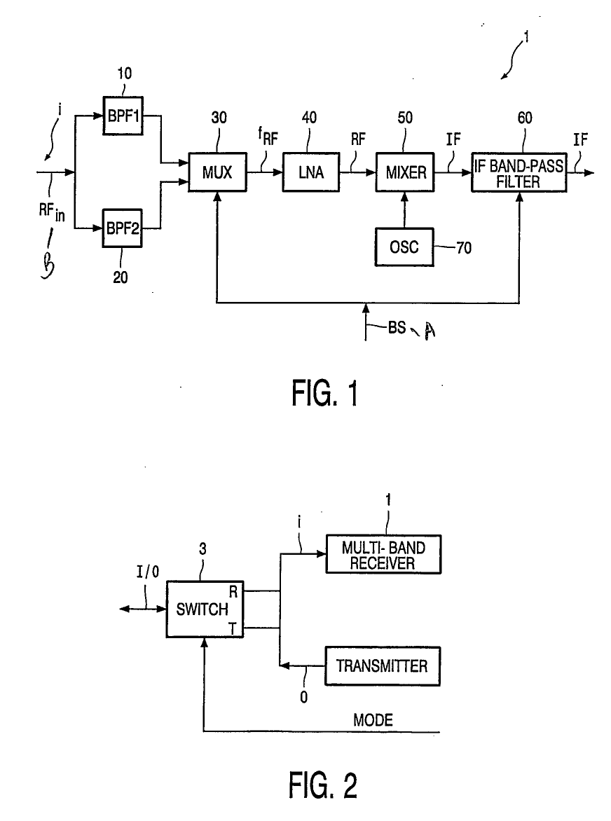

FIG. 1 depicts a block diagram of a multiple band receiver according to the invention,

FIG. 2 depicts a block diagram of a transceiver using the multiple band receiver according to the invention.

FIG. 1 depicts a block diagram of a multiple band receiver according to the invention. The receiver comprises an input I for receiving a relatively high frequency input signal RFin having a frequency f_{RF} situated either in a first frequency band e.g. [2.4-2.5] Ghz or in second frequency band e.g. [5.2-5.8] Ghz. The input signal could be received via an antenna or via a transducer such as an opto-electrical transducer. The input signal is inputted to a first band-pass filter BPF1 and in a second band-pass filter BPF2. A first central frequency of the BPF1 is situated in the first frequency band and a second central frequency of the BPF2 is situated in the second frequency band. Both filters are linear filters i.e. a signal at their outputs has the frequency of the input signal f_{RF}. The output signals of BPF1 and BPF2 are inputted to a multiplexer (MUX) 30. The multiplexer 30 is controlled by a control signal BS. The control signal BS determines which of the output signals from the multiplexer 30 is further transmitted to the receiver 1 i.e. either the output signal of BPF1 or the output signal of BPF2. It is observed that the multiplexer 30 selects the frequency band of the receiver 1. At the output of the multiplexer 30 a signal having the frequency f_{RF} is obtained. Usually an amplitude of the input signal RFin is relatively small and an amplification of the signal is necessary. The signal obtained at the output of the multiplexer is linearly amplified in a low noise amplifier (LNA) 40. An output signal obtained at the output of the LNA 40 has the same frequency as the input frequency i.e. f_{RF} and an amplitude that is proportional to the input signal, having a higher amplitude. The amplified signal obtained at the output of LNA 40 is inputted to a first input of a mixer 50, said mixer being coupled to the LNA 40. A local oscillator (OSC) 70 is coupled to a second input of the mixer 50. The local oscillator 70 generates a periodical signal having a frequency f_{OSC}. The periodical signal is combined with the signal generated by the LNA 40. The mixer 50 generates a signal IF. The frequency of signal IF i.e. f_{IF} is either f_{IF}=f_{RF}−f_{OSC} in upper heterodyning mode or f_{IF}=f_{OSC}−f_{RF} in lower heterodyning mode. Besides the intermediate frequency signal, parasitic signals called image signals are also generated. The mixer 50 is coupled to a IF band-pass filter 60 having a central frequency substantially equal to the intermediate frequency f_{IF}. The IF band-pass filter 60 further comprises image-rejection filters that attenuate an amplitude of the image signals. The image-rejection filters are tuned to the image frequencies, said image frequencies depending on the input signal frequency f_{RF} and on the frequency of the IF signal f_{IF}. The image rejection filters are normally elliptic filters, notch or band-reject filters, preferably realized using passive components. The IF band-pass filter 60 further amplifies the intermediate frequency signal IF for compensating inherent losses obtained during the filtering process. The control signal BS controls the IF band-pass filter 60 such that at the output of the IF band-pass filter 60 a signal having relatively constant amplitude and a frequency substantially equal to f_{IF} is obtained. Said amplitude and frequency of the output signal of the IF band-pass filter 60 are substantially independent of the mode i.e upper heterodyning mode and lower heterodyning mode. If the input signal RFᵢₙ is situated either in the band [2.4-2.5] GHz or in the band [5.2-5.8] GHz a suitable intermediate frequency could be fF=1.5 GHz. A local oscillator 70 generating a periodical signal f_{OSC} situated in [5.2-5.4] GHz band is chosen. The frequency f_{OSC} is used to be combined with the signal f_{RF} in the mixer 50 such that the frequency of the IF signal is independent with respect to the band of the input signal RFᵢₙ. When the frequency of the input signal is situated in the [2.4-2.5] GHz band the upper heterodyning mode is used and when the frequency of the input signal is situated in [3.7-4.3] GHz band the lower heterodyning mode is used, respectively. It is observed that the tuning ratio of the local oscillator i.e. the ratio between the maximum oscillation frequency and the minimum oscillation frequency is relatively low e.g. 1.16. This tuning ratio is relatively easy to be realized even when relatively high frequencies are used. Furthermore the receiver 1 comprises only one local oscillator and only one IF band-pass filter resulting a cheaper receiver. Modern communication networks use quadrature signals and therefore a quadrature local oscillator could be used.

It is observed that the input signal RFin could be generated by an antenna in a wireless communication system, could be a signal generated by a transducer e.g. a photo-detector in an optical network or could be obtained using a mutual coupling e.g. magnetic coupling or charge coupling.

It is further observed that if the input signal Rfᵢₙ corresponds to the standard IEEE 802.11a e.g. f_{RF}=5.2 GHz then the receiver 1 could be used as it is. So, it results that the receiver 1 could be used for receiving signals corresponding to three standards i.e. HIPERLAN, IEEE 802.11a,b.

FIG. 2 depicts a block diagram of a transceiver 100 using the multiple band receiver 1 according to the invention. The transceiver 100 comprises the multiple band receiver 1 coupled to a transmitter 2 via a controllable switch 3. A control signal MODE determines whether the transceiver 100 is used in a receiving mode or in a transmitting mode. Normally, the control signal MODE is a binary signal. In receiving mode the control signal MODE determines an input signal received at an input/output I/O terminal to be inputted to the input terminal I of the receiver i.e. the switch 3 couples the I/O terminal to a terminal R of the switch. In transmitting mode the control signal MODE determines an output signal 0 transmitted by the transmitter 2 to be inputted to the I/O terminal i.e. the switch 3 couples the I/O terminal to a terminal T of the switch. The control signal MODE could be an electrical signal e.g. a voltage, a current, a charge or a non electrical signal i.e. an intensity of light, temperature, pressure.

The transeiver 100 is adapted to transmit signals corresponding to the above mentioned standards being relatively cheap and relatively easy to be practically implemented.

It is remarked that the scope of protection of the invention is not restricted to the embodiments described herein. Neither is the scope of protection of the invention restricted by the reference numerals in the claims. The word ‘comprising’ does not exclude other parts than those mentioned in the claims. The word ‘a(n)’ preceding an element does not exclude a plurality of those elements. Means forming part of the invention may both be implemented in the form of dedicated hardware or in the form of a programmed purpose processor. The invention resides in each new feature or combination of features.

1. A multi-band receiver for receiving an input signal (RFin) having a frequency situated either in a first band or in a second band, said receiver comprising a mixer for combining an amplified signal (RF) having substantially the same frequency as the input signal (RFin) with a periodical signal generated by a local oscillator, said mixer generating an intermediate frequency signal (IF), the intermediate frequency signal (IF) being inputted to an IF band-pass filter having a central frequency substantially equal to a frequency of the intermediate frequency signal (IF), the receiver being characterized in that the central frequency of the IF band-pass filter is substantially independent of a combining mode of the amplified signal (RF) and the periodical signal, the combining mode being selected from an upper heterodyning mode and a lower heterodyning mode.

2. A receiver as claimed in claim 1 wherein the periodical signal generated by the local oscillator is situated in a third band that is substantially independent of the combining mode.

3. A receiver as claimed in claim 1 wherein the third band is between the first band and the second band.

4. A receiver as claimed in claim 1 wherein the IF band-pass filter comprises a plurality of image-rejection filters for attenuating image frequency signals resulting from the mixer, the IF band-pass filter being controlled by a control signal.

5. A receiver (1) as claimed in claim 1 wherein the local oscillator is a quadrature oscillator.

6. A transceiver comprising a receiver as claimed in claim 1, said transceiver further comprising switching means coupled to an input (I) of the receiver and to an output (O) of a transmitter, said switching means controlling a communication mode of the transceiver, the communication mode being selected from a receiving mode and a transmitting mode.
